(19) United States
(12) Patent Application Publication
(10) Pub. No.: US 2012/0150994 A1
(43) Pub. Date: Jun. 14, 2012

(54) SYSTEMS AND METHODS FOR DISTRIBUTING AND FACILITATING THE READING OF A LIBRARY OF PUBLISHED WORKS IN A SERIALIZED ELECTRONIC FORMAT

(76) Inventors: Peter Coad, JR., Los Gatos, CA (US); Alexander Poleschuk, St. Petersburg (RU); Arseniy Taradonov, St. Petersburg (RU)

(21) Appl. No.: 13/292,662

(22) Filed: Nov. 9, 2011

Related U.S. Application Data
(60) Provisional application No. 61/412,281, filed on Nov. 10, 2010.

(51) Int. Cl. G06F 15/16

(52) U.S. Cl. 709/217

(57) ABSTRACT

A system and method is provided for distributing and facilitating the reading of a library of works in serialized electronic format. More particularly, the present invention relates to a system which is able to distribute published works in an electronic format that is parsed into segments of limited length that is consistent with a delivery and receiving system that generally operate on short messages, e.g., Twitter or instant messaging systems and PC and/or mobile devices. A delivery schedule for the work can be defined by a publisher of a work, and/or according to preferences of a user and/or group of users. Multiple works can be selected for receipt in a coordinated and synchronized order, and rewards can be distributed to encourage continued participation by users and groups.

### CROSS REFERENCE TO RELATED APPLICATION

This application claims priority to U.S. Provisional Application Ser. No. 61/412,281 filed on Nov. 10, 2010, entitled “Systems and Methods for Distributing and Facilitating the Reading of a Library of Published Works in a Serialized Electronic Format”, which is hereby fully incorporated by reference.

### BACKGROUND OF THE INVENTION

The present invention relates to distributing and facilitating the reading of a library of published works in serialized electronic format. More particularly, the present invention relates to a system which is able to distribute published works in an electronic format that is parsed into segments of limited length that is consistent with a delivery and receiving system that generally operates on short messages, e.g., Twitter, Facebook or instant messaging systems and PC and/or mobile devices.

Currently, electronic readers have been introduced that allow a user to download an electronic version of a published work onto the reader and read it at the user's leisure. Devices such as Amazon's Kindle, Barnes and Nobles' Nook and Apple's iPad include this type of capability. However, once downloaded, the work is a static file in the reader and requires that the user affirmatively access it as often and for as long as required to complete the reading of the work. In other words, the electronic file is more easily forgotten than even a traditional, partially read book on a bookshelf.

In addition to electronic readers, there also exists web-based electronic message delivery services and systems such as instant messaging, Twitter and Facebook, by which users are able to communicate short, typically personal messages to the mobile devices of either individuals or defined groups. Such systems have become increasingly popular, particularly with younger people, and regular users may experience both a distracting and an addictive aspect to their use.

It would be desirable to have an improved system for distributing and reading libraries of published works that facilitate and encourage a user's systematic reading or studying of a work. Reading groups have long been known and enjoyed as a mechanism in which friends may read a selected published work on the same timetable and meet to discuss it. Such groups have been known to encourage people to begin and complete the reading of published works that they might not have had the determination or discipline to complete without participation in such a reading group.

It would be desirable to introduce a system and method for distributing and facilitating the reading of a library of published works in electronic format. Such a system could allow a user of a device considerable control over the reading experience and thereby facilitate the completion of the reading. An embodiment of such a system could enable a user to, for example, select the work to be read; add a user's own work into the system so that it could be serialized and conveniently distributed back to him; select a defined time period in which the work is to be read; select a rate at which serialized segments of the work are received by the user; select the hours of the day and days of the week on which serialized segments of the work are received by the user; select and vary the identification of a device upon which serialized segments of the work are received; and/or select a variable rate at which serialized segments of the work are to be received by the user (for example a faster early rate of distribution to allow a reader to catch up with others in a reading group with whom she is participating). It is also contemplated that during the reading of a work, a user could adjust prior selections of delivery time, frequency of delivery and/or size of segment desired and the publishing system would adjust delivery accordingly, for example, by serializing only portions of the selected work instead of its entirety at the outset.

The library of content applicable to the present invention may include text in various languages, as well as other digital content such as music, audio books, recorded lectures, etc.

Units or segments of selected content may be delivered in a variety of relevant contexts to facilitate consumption and enjoyment of it by the user. For example, each unit or segment of selected content may include a link to view or listen to a larger portion of the content, as well as to select other related or interesting volumes of content from the content library.

Embodiments of the invention also support and facilitate the selection of multiple items or volumes of content for transmission and receipt in a controlled order or relationship. Multiple items of content can be transmitted and received in an interleaved relationship, for example, one volume during one day and another the next; or a different volume for each day of the week. Different versions of the same published work can also be synchronized and interleaved on a much more granular level, including sentence by sentence or paragraph by paragraph.

Synchronized content delivery can be of particular value in an academic environment, in which receipt of text from a textbook can be coordinated and synchronized with complementary content from other materials such as course study guides and supplemental reading materials.

The invention helps people to publish their texts in an electronic format. One aspect of an embodiment of the invention is the publishing of content such as text by portions during a selected time period using different services (Twitter or Facebook for example) and protocols (could be an SMS protocol).

The size of the serialized content portion could be defined by logical blocks such as verse, stanza, sentence or paragraph. Optionally, the content portion may be further split into several blocks due to the limitation of a delivery protocol or a service; for example, the current 140 character limit applicable to Twitter and SMS or the substantially larger message limit applicable in certain Facebook environments.

An embodiment of the invention could be deployed using the “Twitter account and followers” mechanism, the “Facebook Pages and ‘like’” mechanism, and other such mechanisms. Groups can be formed using the invention, and the invention can also be deployed to serve groups formed elsewhere, for example, in Facebook.

An embodiment of the invention can allow publishers to upload or deliver their content as a single file via the internet or other ways. A publisher can provide a configuration of the settings related to the periodical text portions after the whole text is received by system. Some useful settings might include:

1) A definition of a useful portion for the publication. The following options could be used: verse, stanza, sentence; paragraph or full words less than a defined number of characters.
2) A definition of sections (for example, specific chapters) of interest from the publication.
3) The date and time of first portion publication.
4) The date and time of the last publication or publication frequency.

A publisher could also provide information about the services and protocols that he would like used for publication. For example, a publisher could provide the Twitter account name and password if he decides to use Twitter, and provide similar Facebook data if he would like to publish the text portions via Facebook.

A system according to the present invention could publish the first portion of the text at the date and time specified by the publisher, using the specified services and protocols. The time of publishing of the next portion could then be evaluated according to the settings 2) and 3).

In one embodiment of the invention, a publisher can stop the publications at any time. During the publication (after the first portion publication and before the last portion publication), a publisher may also be able to suspend and then resume publications. The collection of settings related to the period and frequency of publication could be changed. A publisher may offer a section (for example, a chapter) at no charge, offer additional section(s) on a paid basis (payment for the next section or payment for all subsequent sections).

In another embodiment of the invention, a publisher can supplement the original published work with the addition of overall and section summaries and other descriptive content. When a user or group selects a work to be received, it can elect to receive supplementary materials or not.

An embodiment of the system of the present invention may include facilities for automatically dividing a selected work into segments of a length consistent with the distribution system to be used; e.g., if a Twitter account is selected as the distribution mechanism from which a particular user is to receive a selected work, the system may automatically divide the work into a segments appropriate for messages permitted in Twitter. In another embodiment of the system of the present invention, the system can automatically determine the rate at which segments are to be distributed based upon the completion date selected by a user and the length of the work selected.

The system may also include a user interface that enables a user to adjust the rate of delivery of segments of the work, terminate the receipt of the work, postpone for a defined period delivery of segments of the selected work, or limit delivery of segments to specified portions of the day. Additionally, the user interface could enable a user to define a customized order for serialization and distribution of the selected work; including for example, receipt of the first chapter, followed by receipt of the final chapter, followed by receipt of the remainder of the work.

The system may further include a facility on the user's reading device to consolidate segments of the published work received over a time period into a larger segment to facilitate reading, and for determining whether a complete segment of the work has been received. If a complete set of segments was not received, the reader can communicate a request for missing segments.

In addition to enabling users to personalize or customize the distribution of a selected work, an embodiment is also contemplated that enables a group of users to coordinate their preferences and select a distribution schedule that generally permits the group to maintain a consistency of progress in the work, while also accommodating individual user preferences. For example, a group may determine that they desire to make complete the work in 3 months, and be at the same basic point in the work at the end of the first, second and third month to facilitate intermediary discussions and interactions, while at the same time individual users in the group can control individual preferences such as times of day and weekend rates of receipt of segments of the selected work.

An embodiment of the system also enables and supports additional users being able to join a group reading of a work that is already started. Subject to user control, the system can distribute the “current” portion of the work to the late joining user, while also steadily distributing in a logical and serialized form, the earlier portions of the work that the new user has not yet received. In this way a new user can participate immediately in discussions and meetings of the group concerning the current portion the work, while also catching up with the group with respect to earlier portions. Other “catch-up” approaches are also contemplated, depending upon the nature of the work selected.

An embodiment of the system also enables and supports the provision of “rewards” to users who have achieved progress according to the established schedule. Rewards can be of many types, including entitlement to further works from the system, or receipt of related and notable quotes from the work or related works. Rewards can also include receipt of jokes or other desired items of content, at the option of the user. This mechanism for providing users with a sense of accomplishment can serve as a useful encouragement for a user to continue her systematic completion of a selected work.

The system may also include a mechanism for receiving payment from users for published works and for facilitating the formation of reading groups and associated discussion of the published work being read by such group.

It has been determined that for a significant portion of users, a system of the type described herein has the effect of facilitating and encouraging the completion of reading of various works, due to the familiarity and attractiveness of the delivery mechanism, coupled with the systematic and convenient reminders experienced by the user upon the regular receipt of segments of the selected work and interaction with others also reading the selected work.

### SUMMARY OF EMBODIMENTS OF THE INVENTION

A system and method is disclosed for facilitating the distribution of a published work in electronic format. The method may include the steps of receiving from a user the selection of a published work to be distributed; breaking an electronic version of the published work into a collection of serialized electronic segments; and transmitting the collection of serialized electronic segments in a sequence of ordered electronic messages over a defined period of time to a user device to permit the user to read the published work in a logical order. The system may include a content selector configured to receive from a user the selection of a published work to be distributed; a content serializer configured to break an electronic version of the published work into a collection of serialized electronic segments; a content transmitter configured to transmit the collection of serialized electronic segments in a sequence of ordered electronic messages over a defined period of time to a user device to permit the user to read the published work in a logical order. Embodiments of the invention may also include a content combiner to consolidate segments to facilitate review; synchronized delivery and customization for individual study as well as for reading groups and their members; communication facilities for study group coordination and discussion; and interleaved reward content to encourage continued reading.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a high level view of an embodiment of the invention;

FIG. 2 an embodiment of the system for distributing and facilitating the reading of a library of published works in serialized electronic format;

FIG. 3 illustrates additional detail of an embodiment of the system for distributing and facilitating the reading of a library of published works in serialized electronic format;

FIG. 4 illustrates additional detail of an embodiment of the system for distributing and facilitating the reading of a library of published works in serialized electronic format;

FIG. 5 illustrates the logical flow of an embodiment of the system for distributing and facilitating the reading of a library of published works in serialized electronic format;

FIG. 6 provides a screenshot of an embodiment of the system for distributing and facilitating the reading of a library of published works in serialized electronic format;

FIG. 7 provides another screenshot of an embodiment of the system for distributing and facilitating the reading of a library of published works in serialized electronic format; and

FIG. 8 provides another screenshot of an embodiment of the system for distributing and facilitating the reading of a library of published works in serialized electronic format.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order to not unnecessarily obscure the present invention. The features and advantages of the present invention may be better understood with reference to the drawings and discussions that follow.

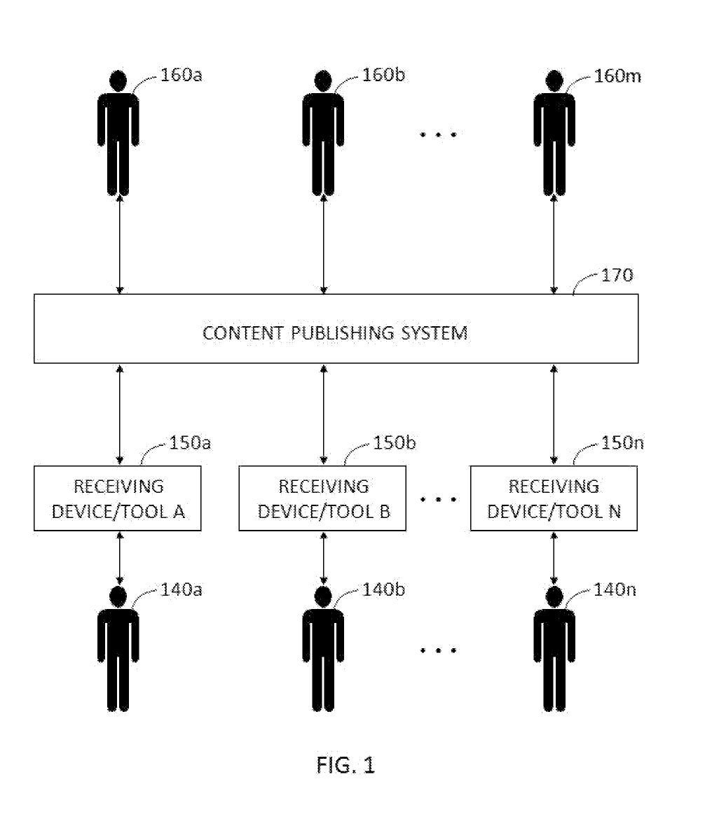

FIG. 1 illustrates a high level diagram of the user and publisher-configurable content publishing system 170. A plurality of publishers 160a-m are able to communicate and interact with content publishing system 170, either through a direct connection or through the internet of other known networking facility. Content publishing system 170 is connected to the internet and/or other known networking facilities for communicating and interacting with publishers 160a-m and with reading devices 150a-n of Users 140a-n. As described in greater detail below, content publishing system 170 receives and maintains a library of works to be published from publishers 160a-m, and publishes them to Users 140a-n in a serialized form, in response to input from both publishers 160a-m and Users 140a-n. The embodiment of the invention illustrated in FIG. 1 is a common but not exclusive form of the invention, inasmuch as it is also contemplated that all of the components shown in FIG. 1 can exist on a single device. This can be a useful embodiment of the invention for a User who has a library of works on his computer and desires that they be presented to her in an ordered, serialized manner to enhance her reading and/or studying of such material.

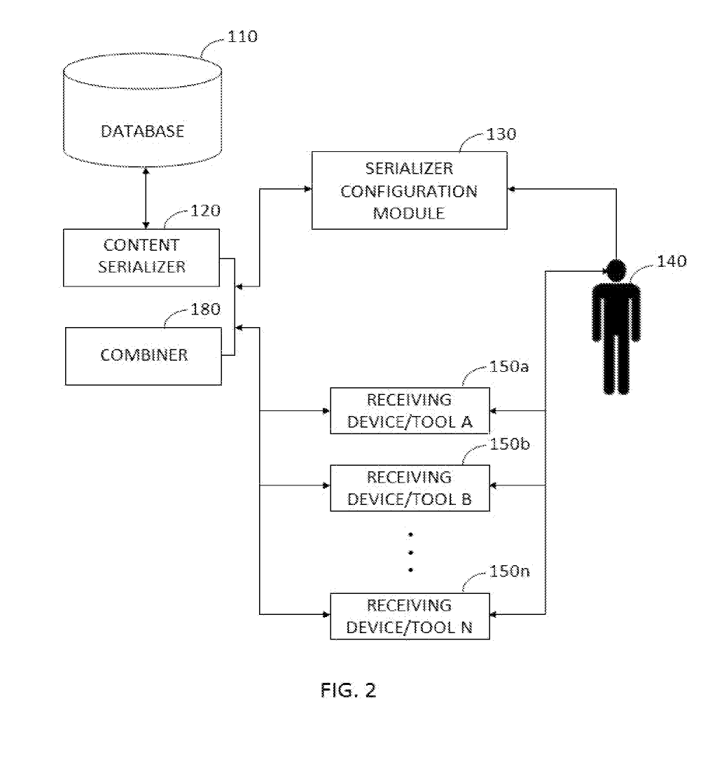

FIG. 2 illustrates a high level diagram of the user and publisher-configurable content publishing system 170.

In this embodiment, a User 140 has access to multiple Receiving Devices and Tools 150a, 150b to 150n. The devices may include mobile devices such as a cellular telephone, an iTouch and/or electronic readers such as a Kindle and a Nook, and PC and laptop computers. Tools may include instant messaging systems and social networking systems such as Facebook and Twitter.

On the opposite side of FIG. 2 is illustrated a user-configurable content Serializer 120. The underlying idea of the Serializer 120 is to deliver a content of interest to a User 140 by segments, in accordance with a defined schedule, on a selected device and/or via a selected tool. The volume of a segment of content, the schedule of delivery, and a device/tool is user personalizable and customizable. That said, the volume of a segment may be limited by data transmission protocol and technical capabilities of a receiving device/tool. For instance, pieces of data transmitted as SMS messages cannot be longer than 140 bytes.

As mentioned above, a User 140 is given the ability to personalize or customize the volume of segments and the delivery schedule. This can be accomplished in one embodiment of the invention using a Serializer Configuration Module 130. A concrete implementation of the Serializer Configuration Module 130 may be a graphical user interface (GUI) in which a User 140 is provided, for example, with a variety of controls to specify a unit of distribution (that is to say, a segment), define a schedule, set a frequency rate and select a receiving device or tool. The system will remember user settings and will operate accordingly.

Database 110 is used to store a library of content intended for serialization. Content may be user-supplied or paid or subscribed or public domain collections (books, songs, photos, periodicals). In certain implementations, all or part of the common database may be distributed across the network, for faster access, as well as for content delivery in accordance with personal preferences and personal consumption patterns. For example, portions of the material of interest to particular user might be distributed to and/or stored in a local database located at the user's device, including without limitation, in a database associated with the user's web browser

A Combiner 180 may also be included on a reader or other receiving device 150a-n to fulfill an operation opposite to serialization: deserialization or combination of serialized content (received to date) into a whole. This function can be used to more efficiently enable the reading of a collection of received segments; for example, in the morning after a set of serialized segments or blocks of content were received overnight.

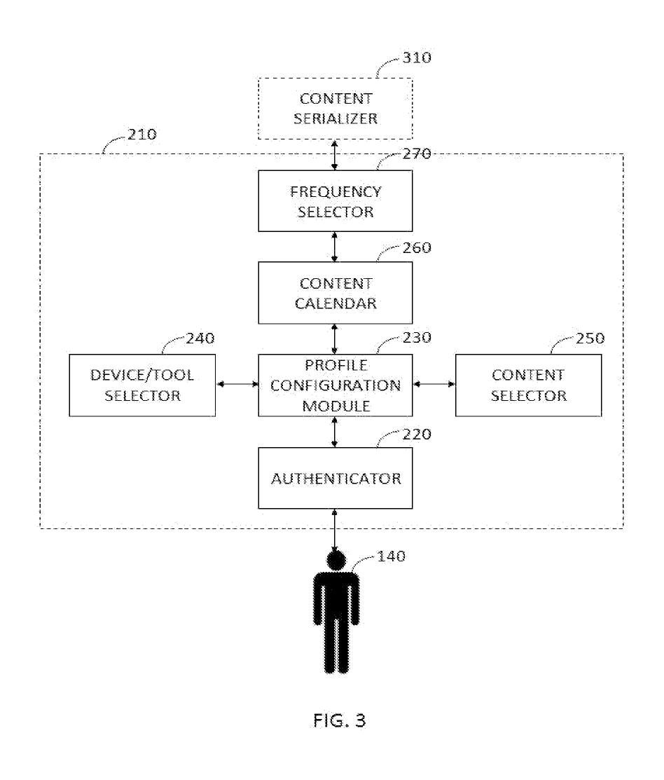

FIG. 3 illustrates an example of an embodiment of the Configuration Module 210 for the Content Serializer 310. Here a User 140 has access to the system through a certain GUI. The User 140 is able to authenticate herself in the system through a standard authentication mechanism 220 so that the system can adjust itself to her needs.

The system includes a Profile Configuration Module 230 that in turn includes four main components, specifically: a Content Selector 250, a Device/Tool Selector 240, a Content Calendar 260, and a Frequency Selector 270.

The Content Selector 250 allows the User 140 to select the content she is interested in. Also the Content Selector 250 allows the User 140 to upload her own content and then select it respectively.

The Device/Tool Selector 240 allows the User 140 to select a receiving device/tool for content being distributed. User 140 can upload necessary identification information to Device/Tool Selector 240 to enable communications to her different reading-capable devices.

The Content Calendar 260 is meant for the User 140 to be able to set the start date (and optionally the end date) when the selected content should start/stop being serialized to her. Besides the start and end date, the Content Calendar 260 may give an ability to select days and hours of the day at which the User 140 would like to receive (or not receive) the serialized segments. Closely related to the Content Calendar 260 is a Frequency Selector 270 that allows a User 140 to further adjust a rate at which serialized segments of the content should be provided to her. For instance, the User 140 may choose to receive serialized segments at a higher rate in the beginning of a delivery operation, with the rate slowing down towards the end. Or, on the contrary, the User 140 may want to receive serialized segments according to an exponential curve, that is to say, with a gradually increasing rate.

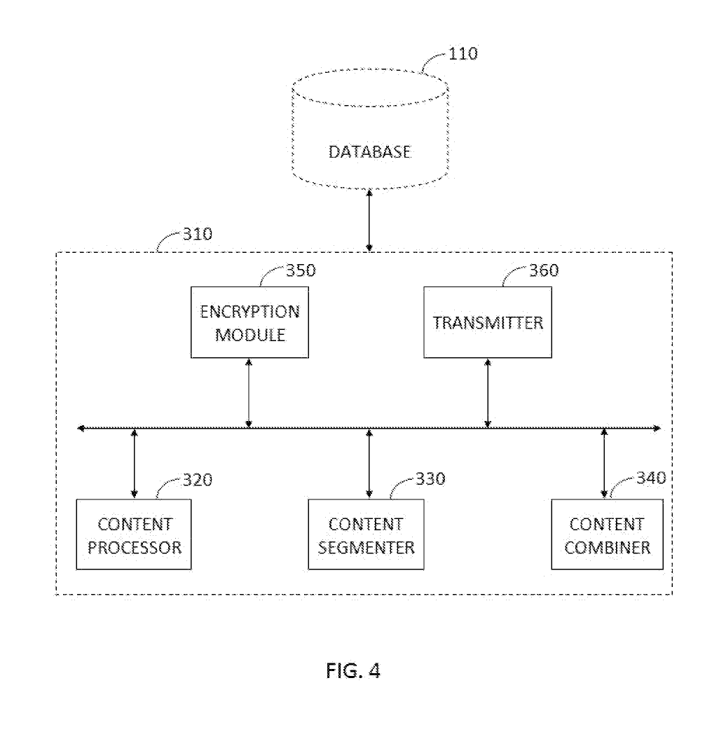

FIG. 4 illustrates an example of an embodiment of the Content Serializer 310. The Serializer 310 may include five components as shown on the diagram, specifically: a Content Processor 320, a Content Segmenter 330, a Content Combiner 340, an Encryption Module 350, and a Transmitter 360.

The Content Processor 320 is intended to process user-provided or third party-provided content in a variety of different formats (MS Word document, PDF document, XML file, HTML page, a plain text, etc.), convert it to the inner format of the system, and save it in the datastore 110.

The Content Segmenter 330 is responsible for dividing content into segments according to user preferences set through the Serializer Configuration Module 210 (see FIG. 2) or in compliance with the technical capabilities of a communication system and/or receiving device or tool. For instance, from the point of view of the User 140 (see FIG. 2), text content may be divided into chapters, sections, paragraphs, sentences, stanzas, couplets, etc., while, from the point of view of technical limitations of the Short Message Service (SMS) protocol, content distributed as SMS messages should be divided into 140 bytes-long chunks.

The Content Combiner 340 puts together serialized content (received to date by the User 140) into a whole. The whole piece of content may be sent to the User 140 as an email message or a file and/or it can be viewed by the User 140 on a site.

The system may include an Encryption Module 350 that is especially useful when distributing paid content rather than public.

The Transmitter 360 does the job of sending segmented content to target devices and tools. Communication is supposed to be done mostly via the Internet or may be done locally on her computing device. That said, connection through Local Area Network (LAN) or Wide Area Network (WAN) is also possible.

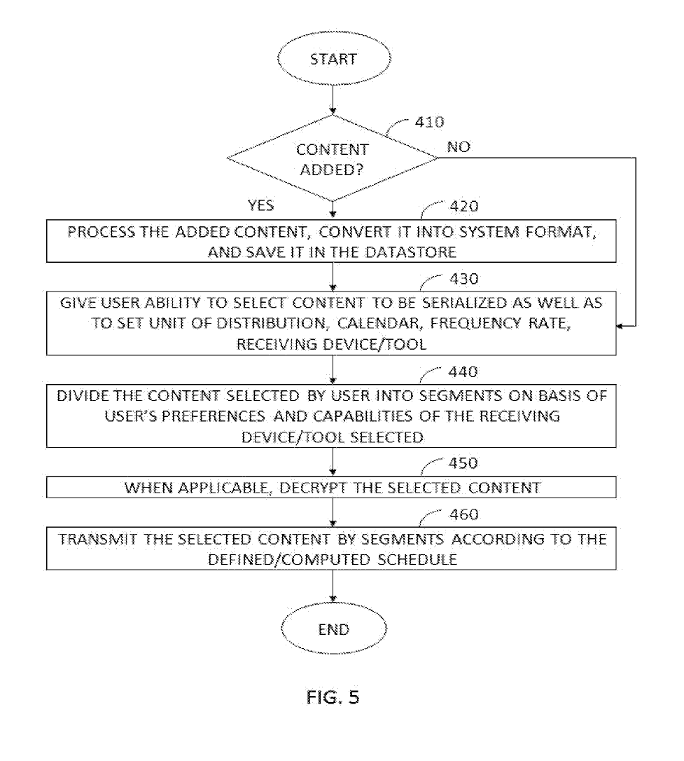

FIG. 5 illustrates a flow diagram for work flow on the transmitter side of the system. The method starts and progresses to step 410 where it is checked whether a User has added some content to the system. If yes, the system processes the added data that may be in a variety of formats (MS Word, PDF, XML, HTML, etc.), converts it in the system format and saves it in the data store, at step 420.

If no data has been added, or after the added data has been processed, then the process progresses to step 430 where the system provides a User with GUI controls allowing her to select content to be serialized, specify a unit of delivery, and define a schedule of distribution. In particular, a User can set the start date (and optionally the end date) when the selected content should start/stop being serialized to her. Besides the start and end date, a User can select days and hours of the day at which she would like to receive (or not receive) the serialized segments. A User can further tune the distribution schedule by specifying a frequency rate. For instance, a frequency rate can be set to be higher in the beginning of a delivery operation or, on the contrary, closer to its end.

Also at step 430, a User chooses a receiving device/tool for serialized content. The system is designed to be able to deliver content to a variety of devices and tools ranging from mobile devices and PCs to social networks such as Facebook and Twitter.

After a User or Group has selected the content she is interested in and, optionally, specified her preferences concerning the schedule of distribution, the process goes to step 440, at which the system makes the content ready for serialization. This stage includes dividing the content into segments to fit the schedule formed by a User or Group at the previous step. The system computes what will be a minimal unit of distribution (a segment) on basis of user's decision regarding what is to be a unit (for instance, a chapter, section, paragraph, sentence, stanza) as well as on basis of the timetable and/or frequency rate. At last but not the least, the system may take into account technical capabilities of the receiving device/tool selected. If it is, for instance, a mobile device or Twitter, the system will divide the content into segments fitting in the Procrustean bed of SMS messages, that is to say, into segments no longer than 140 bytes. The system may also perform a more sophisticated determination that is responsive to both the schedule preferred by a Group, and preferences of individual Users within the Group.

At step 450, the selected content may be decrypted, if applicable, and payment mechanisms can be applied to the selection, as desired.

Finally, at step 460, the system transmits the content by user-specified or computed segments according to the schedule of distribution until the volume of data to be delivered is exhausted or a User of a Group cancels the request to receive the content selected earlier.

### Synchronized Content

In certain fields of study, a scholar might like to receive content in a synchronized sequence. For example, Biblical students often like to compare multiple versions of the same portion of the text, whether in the same language or in different languages. Most versions of the OT or NT are complete, except for an occasional verse that might be missing or added. So if a version is missing a verse, the version may go silent for that verse.

In one embodiment of the present invention, a User 140 can sign up for a synchronized collection of segments of multiple versions, e.g., Spanish and English of the Bible or other classic work. At preselected intervals, the User 140 will receive a segment from each related work; e.g.,—the same verse—from each version of the Bible, with that verse in Spanish and also in English.

Similarly, if a User selects any work in multiple languages, he can choose to receive them in a synchronized way.

This capability of the present invention could become a real help in language learning. Over time, a student could begin weaning himself from one language (Spanish) to become over time less and less frequent, so that eventually one transitions to just the language he is learning (English).

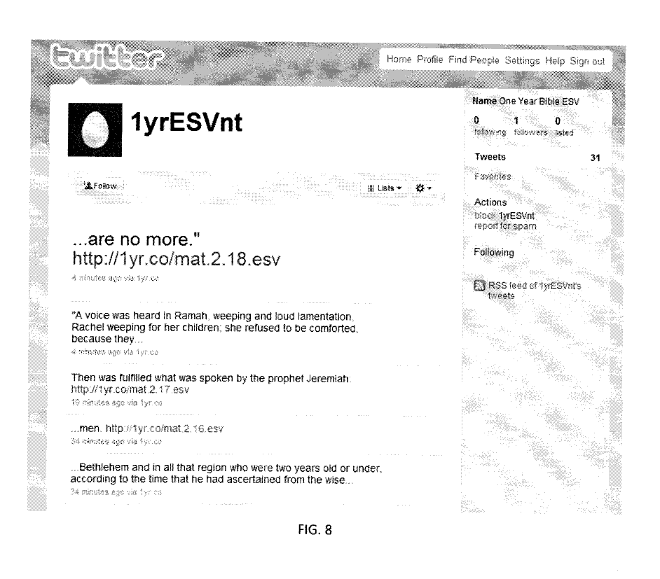

FIG. 8 provides an exemplary screen shot of a Twitter-based content serializer. The serializer was posting messages to a test account on Twitter during several hours with an interval of 15 minutes. The unit of distribution is a Bible verse. If a verse is longer than 140 characters (which is the Twitter's limit), it was posted as two or more tweets.

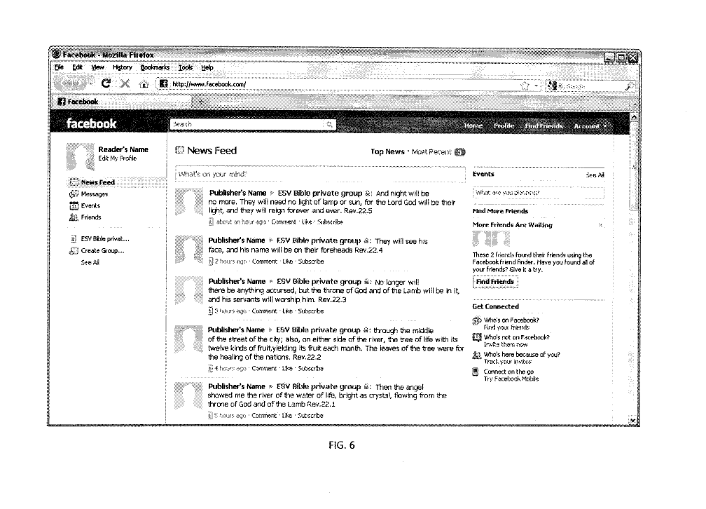

FIG. 6 provides an exemplary screen shot of a reader 150a that has received a series of segments from a Facebook-account based content serializer and publisher. The serializer was posting messages to a test account of Facebook's News Feed during several hours with an interval of 1 hour. The unit of distribution is a Bible verse. If a verse is longer than 401 characters (which is the Facebook's post size limit), it was posted as two or more news segments.

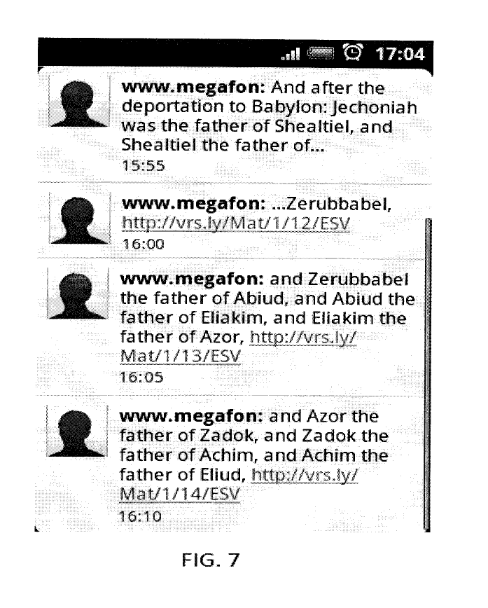

FIG. 7 provides an exemplary screen shot of a reader 150a that has received a series of segments from SMS-based content serializer. The serializer was posting messages to a test account of a Mobile Phone HTC Hero during several hours with an interval of 5 minutes. The unit of distribution is a Bible verse. If a verse is longer than 140 characters (which is the SMS size limit), it was posted as two or more messages.

A deserializer module can also be included on reader devices 150a-n to logically re-associate and combine multiple received segments of a work into a larger portion upon the reader, for example to facilitate a user catching up to the current flow if she has been unable to follow the received segments in real or near-real time. The deserializer module may also include the capacity to examine the stream of segments received by a reader device 150a-n and determine if a complete sequence of segments has been received. If the deserializer determines that a segment or segments has not been received, a message can be returned to serializer and publisher 160a to prompt the re-transmission of such segment(s).

What is claimed is:

1. A method for facilitating the distribution of a published work in electronic format, comprising:
receiving from a user the selection of a published work to be distributed;
breaking an electronic version of said published work into a collection of serialized electronic segments; and
transmitting said collection of serialized electronic segments in a sequence of ordered electronic messages over a defined period of time to a user device to permit said user to read said published work in a logical order.

2. The method as set forth in claim 1, wherein said defined period of time is defined by a user.

3. The method as set forth in claim 1, wherein the frequency of delivery of segments is defined by a user.

4. The method as set forth in claim 1, wherein said user device is defined by a user.

5. The method as set forth in claim 1, wherein the frequency of transmission of said ordered electronic messages is based at least in part upon said defined period of time.

6. The method as set forth in claim 5, wherein said frequency of transmission varies according to time of day.

7. The method as set forth in claim 5, wherein said frequency of transmission varies according to day of week.

8. The method as set forth in claim 5, wherein said frequency of transmission is different at different points in the reading of said published work.

9. The method as set forth in claim 1, further comprising the step of forming a group of users who desire to read said published work together.

10. The method as set forth in claim 1, further comprising the step of enabling the members of said group of users to communicate with each other regarding said published work.

11. The method as set forth in claim 1, further comprising the step of a user to select multiple items of content to be serialized and received during an overlapping time period.

12. The method as set forth in claim 11, further comprising the step of synchronizing the delivery of serialized segments of said multiple items of content.

13. The method as set forth in claim 1, further comprising the step of deserializing multiple segments of received content.

14. The method as set forth in claim 1, further comprising the step of enabling the payment by a user for receipt of said published work.

15. The method as set forth in claim 1, further comprising the step of providing rewards to a user upon completion of said user of a prescribed portion of a selected work.

16. The method as set forth in claim 1, further comprising the step of enabling the preferences of a group of users to be used in determining the selection of a work.

17. The method as set forth in claim 1, further comprising the step of enabling the preferences of a group of users to be used in determining the delivery schedule for a work.

18. A system for facilitating the distribution of a published work in electronic format, comprising:
a content selector configured to receive from a user the selection of a published work to be distributed;
a content serializer configured to break an electronic version of said published work into a collection of serialized electronic segments; and
a content transmitter configured to transmit said collection of serialized electronic segments in a sequence of ordered electronic messages over a defined period of time to a user device to permit said user to read said published work in a logical order.

19. The system as set forth in claim 18, further comprising a profile configurator for controlling selections made by a user relating to reading said published work.

20. The system as set forth in claim 18, further comprising an authenticator for confirming the identity of said user.

21. The system as set forth in claim 18, further comprising a content calendar for controlling the timing of distribution of selected content.

22. The system as set forth in claim 18, further comprising a frequency calculator for determining the frequency of transmission of said serialized electronic segments.

23. A device for presenting a work to a user in a serialized format, comprising:
a content selector configured to enable a user to select a work to be presented to said user in a serialized format;
a receiver for receiving segments of a selected work in serialized form from a data source containing a selected work;
a user interface to enable a user to select received segments of a selected work to be presented to the user; and
a presentation module for presenting a selected segment of a selected work to the user.

24. The system as set forth in claim 23, further comprising a deserializer for recombining a plurality of segments of said selected work in an appropriate order.

25. The system as set forth in claim 23, further comprising a segment checking module for determining if a segment has not been received in proper sequence.

26. The system as set forth in claim 23, wherein said user interface further comprises a delivery controller to enable a user to select the time over which a selected work is to be received.

27. The system as set forth in claim 23, wherein said user interface further comprises a delivery controller to enable a user to select the frequency in which a selected work is to be received.
